(19) United States
(12) Patent Application Publication
(10) Pub. No.: US 2021/0235261 A1
(43) Pub. Date: Jul. 29, 2021

(54) Location Aware User Model That Preserves User Privacy Of Sensor Data Collected By A Smartphone

(71) Applicant: Koa Health B.V., Barcelona (ES)

(72) Inventors: Johan Lantz, Barcelona (ES); Aleksandar Matic, Lloret de Mar (ES)

(21) Appl. No.: 17/232,127

(22) Filed: Apr. 15, 2021

Related U.S. Application Data
(63) Continuation-in-part of application No. PCT/EP2020/078075, filed on Oct. 16, 2019.

(30) Foreign Application Priority Data
Oct. 17, 2018 (EP) 18382740.1

(51) Int. Cl. H04W 12/02; G06F 21/60; H04L 9/06; H04W 12/63; H04W 4/021

(52) U.S. Cl. CPC H04W 12/02; G06F 21/60; H04L 9/0643; H04L 2209/16; H04W 4/021; G06F 2221/2111; G06F 2221/2151; H04W 12/63

(57) ABSTRACT

A method for preserving the privacy of sensor data from a smartphone associates the sensor data with heatspots instead of with actual geographic locations. Sensor data is collected from a plurality of sensors installed on the smartphone of a user. The sensor data is grouped by a plurality of heatspots in which the sensor data was sensed by the smartphone. Each heatspot corresponds to a geographic area that has a distinct significance to the user, such as the user's home or workplace. Each of the heatspots is labeled with a unique identifier associated with the corresponding geographic area. The collected sensor data together with the unique identifier of the heatspot in which the sensor data was sensed and a timestamp of when the data was sensed is transmitted from the smartphone to a server. Information identifying the actual geographic area in which the sensor data was sensed is not transmitted.

### CROSS REFERENCE TO RELATED APPLICATION

This application is filed under 35 U.S.C. § 111(a) and is based on and hereby claims priority under 35 U.S.C. § 120 and § 365(c) from International Application No. PCT/EP2020/078075, filed on Oct. 16, 2019, and published as WO 2020/079075 A1 on Apr. 23, 2020, which in turn claims priority from European Application No. EP18382740.1, filed in the European Patent Office on Oct. 17, 2018. This application is a continuation-in-part of International Application No. PCT/EP2020/078075, which is a continuation of European Application No. EP18382740.1. International Application No. PCT/EP2020/078075 is pending as of the filing date of this application, and the United States is an elected state in International Application No. PCT/EP2020/078075. This application claims the benefit under 35 U.S.C. § 119 from European Application No. EP18382740.1. The disclosure of each of the foregoing documents is incorporated herein by reference.

### TECHNICAL FIELD

This invention relates to a method, and corresponding system and computer programs, for ensuring user privacy for sensor data collected from a mobile computing device such as a smartphone.

### BACKGROUND

Collecting large amounts of data from personal computing devices, and moreover acquiring rich information about an individual, naturally comes with the risk of invading the person's privacy. Regardless of whether the user agrees with the consent request that explains in detail the data that is being collected and the intended use of that data, the European General Data Protection Regulation (GDPR) strongly encourages data minimization. More importantly, the GDPR prohibits the collection of data that is not required in order to deliver the service. Being able to obtain the same results and/or modeling accuracy with less data is hugely beneficial for any data-dependent service, as doing so decreases the risk of exposing personal information while enhancing the user's trust and his or her perception of control.

Some current apps take advantage of smartphone sensors to deliver or improve their services. Thus, they often rely on privacy sensitive data. One common feature is geofencing, in which an app can interact with the physical world to improve engagement and timeliness of interaction with a user.

New techniques and solutions are therefore needed to process personal information in a more anonymous way, so that the information can be shared with backend services capable of building advanced user models and so that machine learning algorithms can be applied without the risk of exposing information that could uniquely identify a user.

### SUMMARY

A method, system and computer program for providing a location aware user model preserves the user's privacy. The method involves: (a) collecting, by a sensor capture module, sensor data from a plurality of sensors installed on a mobile computing device of a user; (b) processing the collected sensor data in an anonymous way by grouping the collected sensor data into different heatspots corresponding to different areas of distinct significance to the user, each of the heatspots having a radius; (c) labeling each of the heatspots with a unique identifier corresponding to a predetermined area; and (d) generating, by a computer, a location aware user model based on the unique identifiers. The location aware user model is suitable for providing recommendations to the user via the mobile computing device, for performing studies and/or providing an input to other user models.

A method for preserving the privacy of sensor data from a mobile computing device associates the sensor data with heatspots instead of with actual geographic locations. Sensor data is collected from a plurality of sensors installed on the mobile computing device of a user. The sensor data is grouped by a plurality of heatspots in which the sensor data was sensed by the mobile computing device.

For example, a mobile app running on the mobile computing device groups the sensor data by the plurality of heatspots. Each of the heatspots corresponds to a geographic area that has a distinct significance to the user, such as the user's home or workplace. Each of the heatspots is labeled with a unique identifier associated with the corresponding geographic area.

The collected sensor data together with the unique identifier of the heatspot in which the sensor data was sensed and a timestamp of when the sensor data was sensed is transmitted from the mobile computing device to a server. In one embodiment, the mobile computing device first receives an indication of a hashing technique and then transmits the unique identifier to the server after the unique identifier is obfuscated using the hashing technique. Information identifying the actual geographic area in which the sensor data was sensed is not transmitted. Thus, the transmitting of the collected sensor data together with the unique identifier of the heatspot does not reveal the physical whereabouts of the user.

The mobile computing device transmits to the server the collected sensor data together with a timestamp indicative of when the sensor data was sensed or indicative of when the mobile computing device entered the heatspot. A recommendation is provided to the user of the mobile computing device that depends on the geographic area in which the sensor data was sensed. In one aspect, the recommendation recommends that the user engage in an interactive therapy.

Other embodiments and advantages are described in the detailed description below. This summary does not purport to define the invention. The invention is defined by the claims.

### BRIEF DESCRIPTION OF THE DRAWING

The accompanying drawings, where like numerals indicate like components, illustrate embodiments of the invention.

FIG. 1 graphically depicts a simple heatspot model used by the proposed invention.

FIG. 2 is a simplified visualization of how different heatspots are connected to each other. The transition from 2-4 indicates a missed location sample in a regular interval.

FIG. 3 graphically depicts an example in which both user 1 and user 2 spend a significant amount of time in anonymized heatspot #56aa34532.

FIG. 4 is a flow chart illustrating the general flow from device detection through analysis to recommendation.

FIG. 5 is an illustration of how the same device generates two different identifiers when reported to the computer/server.

FIG. 6 is an illustration in which user A and user B report user C to the server, but only the manufacturer identifier is preserved.

FIG. 7 is an illustration of how user A and user B would both report the same anonymized identifier for user C.

FIG. 8 illustrates how user B's privacy settings eliminate user A from the devices reported for analysis because it is outside of the predefined range.

### DETAILED DESCRIPTION

Reference will now be made in detail to some embodiments of the invention, examples of which are illustrated in the accompanying drawings.

In a first aspect of the present invention, a method for providing a location-aware user model that preserves the user's privacy involves collecting, by a sensor capture module, sensor data from a plurality of sensors installed on a mobile computing device, such as a smartphone, of a user. Then a computer processes the collected sensor data in an anonymous way by grouping the collected sensor data into different geographic heatspots. Each of the heatspots is labeled with a unique identifier corresponding to a predetermined area. A location-aware user model is generated based on the unique identifiers. Thus, the location-aware user model can be used to provide recommendations to the user via the mobile computing device, perform studies and/or provide an input to other user models.

The heatspots include different areas of different significance for the user. The heatspots have a given radius, both different or equal to each other, that can range from a few meters to several kilometers.

The collected sensor data includes one or more of the following: accelerometer data, activity data, data about installed applications in the computing device, data about a battery level of the computing device, data about Bluetooth beacons in the heatspot, call logs, data about the computing device including model and/or brand name, data indicating whether a headset is plugged in or not, Internet logs and/or web surfing history, current lux level, location data, whether music is playing or not, ambient noise level, pedometer data, network data about the computing device including roaming, operator, cell tower, data TX/RX, mobile/WiFi, airplane mode and/or country, data about places or types of establishments nearby the heatspot, data indicating whether a screen of the computing device is on/off, SMS logs, data indicating activity transitions of the user, and/or data indicating walking dynamics of the user.

The sensor capture module may reside in the platform layer of the mobile application, meaning that there is a separate version for iOS® and Android®. Nonetheless, the concept is not limited to any specific platform, and similar features could be made available on other mobile platforms, embedded systems (IoT) or even web browsers.

The processing of the collected sensor data further involves providing at least one timestamp to each heatspot indicating the moment in time at which the user reached the heatspot.

Each unique identifier is encrypted based at least on a part of the location coordinates of the predetermined area. The method is applicable to a plurality of different users active in the same heatspots, such that a location-aware user model is generated for each one of the plurality of different users. In this case, the computer calculates behavioral patterns between different users by correlating the generated location-aware user models of the different users.

Alternatively, the computer may also compute a seed and use the computed seed to automatically create and encrypt a random salt key. Then the computer determines a hashing technique (e.g., SHA-256) that is used to obfuscate the different heatspots.

The encrypted random salt key and the determined hashing technique is transmitted to the mobile computing device of each user of the plurality of different users. Upon reception, each mobile computing device applies the hashing technique with the salt key to every heatspot and further transmits a hash to the computer.

In another embodiment, a computer program product involves a computer-readable medium including computer program instructions encoded thereon that when executed on at least one processor in a computer system causes the processor to perform the operations indicated herein. The present invention achieves an optimal trade-off between the user modeling power and the level of data sensitivity. The present invention increases user trust and decreases risk in case of data breaches. Moreover, higher compliance with data regulations is achieved.

The present invention focuses on privacy preservation while still allowing for sensor data collection and user modeling. The novel method operates on sensor data that can potentially expose private information and enables that information to be anonymized without losing the ability to process the data in a personalized way.

The aim of the present invention is to build a good user model that can be 100% anonymous using data that is anonymized while still being equally or close to equally relevant as its non-privacy invasive counterpart.

Continuously uploading location information for a user exposes the user's personal information to the threat of misuse. On the other hand, continuous location information can provide a rich insight into the users' daily activities. In order to reduce the exposure risk and to preserve user privacy, the novel method uses the concept of a “heatspot”, which is a geographical area of distinct significance for the user. The heatspot concept is implemented in such a way that for each location obtained from the user's mobile computing device, the location is compared to a list of locally cached geographic areas within a certain radius. If there is a match with a previous location, the number of “hits” in that area is increased. The benefit of matching geographic area is that it does not require continuous monitoring. To the contrary, by obtaining a location at regular or fairly regular intervals, the reliability of the heatspot importance is improved.

As an example, user A spends most his time at home or at work and has a 30 minute commute between the two locations. A simplified day in the life of user A looks like this:

07:00 wake up

08:00 leave for work

08:30 arrive at work

17:00 leave work

17:30 arrive home

23:00 go to bed

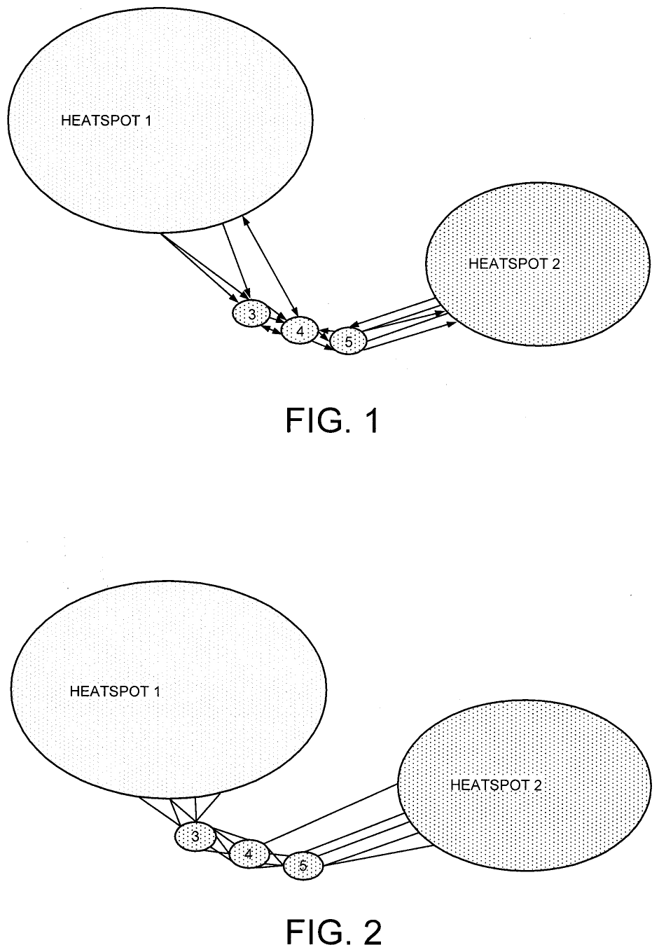

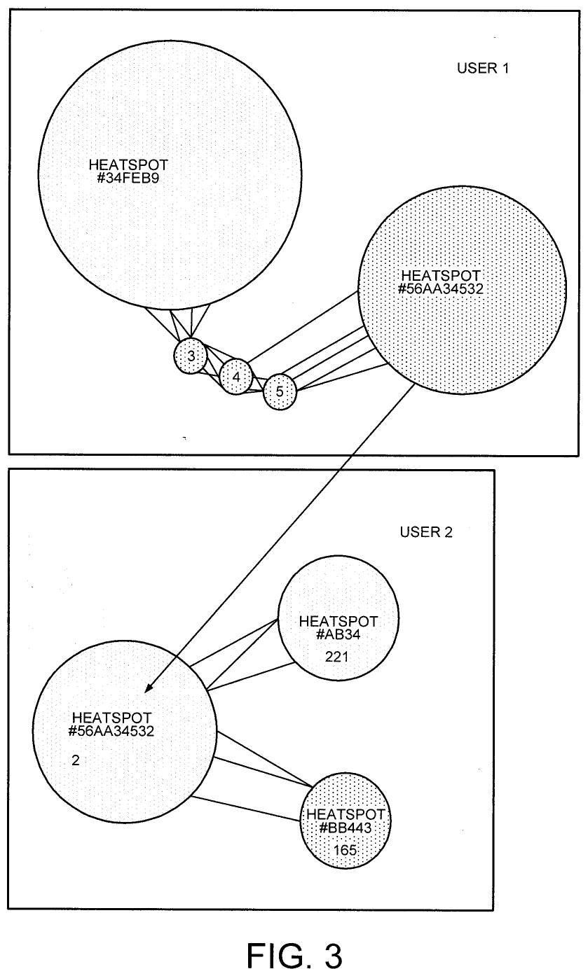

With an application that continuously monitors user A's exact location, the user's exact whereabouts over time would be tracked, and the corresponding location information would persist in the backend of the application. However, if the sensor-capture module uses a heatspot approach before uploading the data for processing, user A's activities would be grouped into areas of different significance, as illustrated in FIGS. 1-2.

Now a machine learning algorithm can quite easily detect a pattern from this simplified case, identifying heatspot 1 as user A's home, heatspot 2 as user A's workplace and heatspots 3-5 as intermediate points, such as locations along user A's commute.

In one embodiment, if the heatspot identifier is reported in combination with a timestamp, the granularity is further improved because doing so allows transition monitoring between heatspots and allows user flows to be simulated without exposing location details.

Depending on the embodiment, more or less precision can be desired or required, which the user can control using the heatspot model. This is accomplished by displaying an option on the application or user level, which controls the size of the heatspot.

If fine precision is needed, for instance for a mental wellness app that needs to know if the user is leaving home at all, the heatspot radius must be relatively small to be able to determine if the user is at home or in another heatspot. For more generic purposes, it might be sufficient to have a larger heatspot radius. For instance, if it must be detected that the user is travelling for work or spending weekends away without disclosing the location, then a heatspot the size of a city would be more than sufficient. In both cases, the exact location of the user is never revealed. But having the option to tune the granularity offers the user more peace of mind.

In another embodiment, the heatspot is simply labeled or identified with an identifier that is specific to each user, i.e., users A, B and C will have heatspots 0, 1, 2, respectively.

In another embodiment, the identifier is further encrypted based at least on a part of the location coordinates of the predetermined area. In this case, the computer is able to correlate behaviors, movements, etc. between users who are active in the same heatspots. Encrypting heatspot identifiers using location coordinates is also used to study whether users who spend a lot of time in similar areas also share similar behaviors, problems, etc.

For many services, developing behavioral models is highly dependent on establishing statistical relationships among different users, which therefore requires mapping between their collected data points, such as location. However, mapping between user data points is impossible if different users have different heatspot annotations. In order to allow for mapping between user data points while still fully preserving the users' privacy, the computer randomly creates a seed for creating a salt key. Then, the computer automatically creates the random salt key (with a pre-defined number of characters), encrypts the key and stores it for the future use. The computer also decides on a hashing technique to be used to obfuscate the locations, e.g., SHA-256. The computer can change a hashing technique over time to use the most current technique. The computer communicates the hashing technique and the encrypted salt key to the mobile computing device of the user. This transfer of the key and hashing method is performed in the same way that a server and client side exchange a password, without any of the sides storing the raw value. Finally, the mobile computing device applies the hashing technique with the salt key to every location and sends only a hash to the computer.

Each different computer will have its own salt key. Therefore, even if the same hashing function is coincidentally used, and the two computers communicate to each other, they cannot map their users. This is extremely important because crossing two different data sets can endanger user privacy in unpredictable ways, and location information if uniquely hashed can serve as a key to identify users.

Therapy Application:

In one embodiment, in particular for a company developing a therapy application, the application includes: an interactive therapy program designed to address the symptoms, a chat with the therapist or an anonymous support group, and other features. While the user may follow the program at an individual pace and interact with the therapist or support group on random occasions, these are all user initiated actions. There is also a need for preventive measures, and detecting anomalies in the movement patterns of the user is a good indicator that something might be wrong.

In the case of user A having a condition that makes it incredibly hard to leave home, for example, due to anxiety, depression or bad self-image, it is valuable for the treatment application proactively to detect behavior that could potentially be harmful. However, tracking the user's location and actions at a detailed level will be extremely privacy invasive and poses great challenges on the security of the backend storage (or computer's storage). On the other hand, if the user is tracked based on anonymous heatspots, and the algorithms in the backend (i.e., in the computer) have learned where the home heatspot is, then it can easily be detected whether the user has not left that comfort zone for X days and in this case notify either the physician or the support group.

As a first step the application can query the user about the current perceived health state, then recommend the user to take a walk and finally “alert” the peers about a potentially unhealthy situation. In no case would this expose the user's exact whereabouts.

As an example, the app can provide a service for detecting early signs that a user is going to experience a mental health crisis, such as depression, mania, or a similar condition. The literature shows that mobility patterns are important predictors of upcoming crises. However, using raw locations is considered to be extremely privacy invasive, and in particular patients do not feel comfortable with sharing it. From the service side, storing raw locations poses additional requirements. For instance, the GDPR imposes “high” security measures that are extremely challenging to comply with particularly for smaller companies (such as physical security, logging not only electronic access to the server but authenticating people who are in the physical vicinity of the server and granting special permissions, etc.). Storing heatspots instead of raw location data eliminates the data security requirements, while still allowing for the models to incorporate the analysis of mobility patterns. In one model, a sequence of very specific locations is a predictor of a crisis. The algorithm used by the model can have the same accuracy using heatspots as it has using raw location data.

Geofencing Services:

In another embodiment, if a mobile app delivers recommendations to its users, the right timing is crucial for their engagement. Knowing in which heatspots its users are more responsive for specific time periods, the “right time” algorithm can work without the need to store actual location data. In the same way, if some features of the mobile app rely on the proximity of its users (e.g., buying/selling items in the neighborhood), this function can work without the raw location data. Moreover, the concept of heatspots will support the case in which users set different granularity of location obfuscation (e.g., 100 m versus 1 km), while indicating the precision in the interface.

Browser Logs:

Having access to the internet browsing logs of a user provides a deep insight into not only internet browsing habits but also the type of content consumed, user's preferences, and tastes. Many studies show that location information and internet history are the data categories with the highest privacy concerns. Thus, the same concept of heatspots can also be used for the obfuscation of internet logs, representing online whereabouts as opposed to geographic whereabouts in real life. In order to apply the invention in the same way to internet logs as for physical locations, the granularity is defined in the following way. Note that the granularity in the physical location use case was defined based on distances. First, the following visibility levels of the internet logs are defined:

1) timestamps of http(s) access, i.e., no information about the requested domain;

2) hashing only the domain name and sending it with the server, e.g., cnn.com shared as “ah13f;323f239tu2foiewewf”, uniquely for the same service;

3) hashing the address up to the second hash “/” and sharing the hash with the server, e.g., cnn.com/sport/shared as “24otih3094tfe2fij42” uniquely for the same service;

4) hashing address at the page level and sharing it with the server, e.g., “en.Wikipedia.org/wiki/Josip_Broz_Tito” shared as “fuh8742hjas94ht2′[g”, uniquely for the same service;

5) hashing the name of the first level category that the visited website or a service belongs to, e.g., the first level category Alexa defines as Adult, Arts, Business, Computers, Games, Health, Home, Kids and Teens, News, Recreation, Reference, Regional, Science, Shopping, Society, Sports, World;

6) hashing the name of the second level category that the visited website or a service belongs to, e.g., for Science Alexa defines 29 second level categories including Academic Departments, Agriculture, Anomalie & Alternative Science, Astronomy, Biology, etc.;

7) hashing the name of the third, fourth, etc. level category that the visited website or a service belongs to (the number of the category levels is related to the dictionary used);

8) sharing a non-hashed name of the first category level that the visited website or service belongs to;

9) sharing a non-hashed name of the second category level that the visited website or a service belongs to;

10) sharing a non-hashed name of the third category level that the visited website or a service belongs to;

11) sharing a non-hashed domain name; and

12) sharing a non-hashed domain name up to the second hash “/”.

Each next visibility level has one degree of granularity lower than that of the previous level.

As an illustration, the above list is ordered from the lowest to the highest granularity with respect to the heatspot concept. However, variations in the above categories are allowed as long as they provide different levels of the URL visibility with the related partial or full obfuscation.

As it has been demonstrated here, https://arxiv.org/pdf/1710.00069.pdf different URL visibility levels indeed provide different user modeling predictive power (even only the timestamps can be sufficient for accurate user models).

Bluetooth Data:

The Bluetooth sensor is responsible for scanning the surroundings for Bluetooth or Bluetooth LE devices. This provides a way to detect which beacons are normally available in the surroundings of the user. The most obvious example is a Bluetooth smartphone that would identify another individual. But other devices, such as smart speakers, TV's etc., could indicate the incoming level and other interesting parameters that are valuable for user modeling.

Collecting this data, however, may come with serious privacy concerns. For instance, there are adult items that have Bluetooth, and the Bluetooth identifier easily reveals the manufacturer. Moreover, having raw Bluetooth identifier can indirectly reveal extremely privacy sensitive information, e.g., which exact device a user is in the surrounding of at 2 am during the weekends. It could, however, still be valuable for the model to know that this device is frequently or repeatedly present in the surroundings of the user. If used in a raw format, it is possible to reverse engineer if the identifier corresponds to a mobile phone (therefore a person) or to a specific device, TV, headphones, laptop, etc.

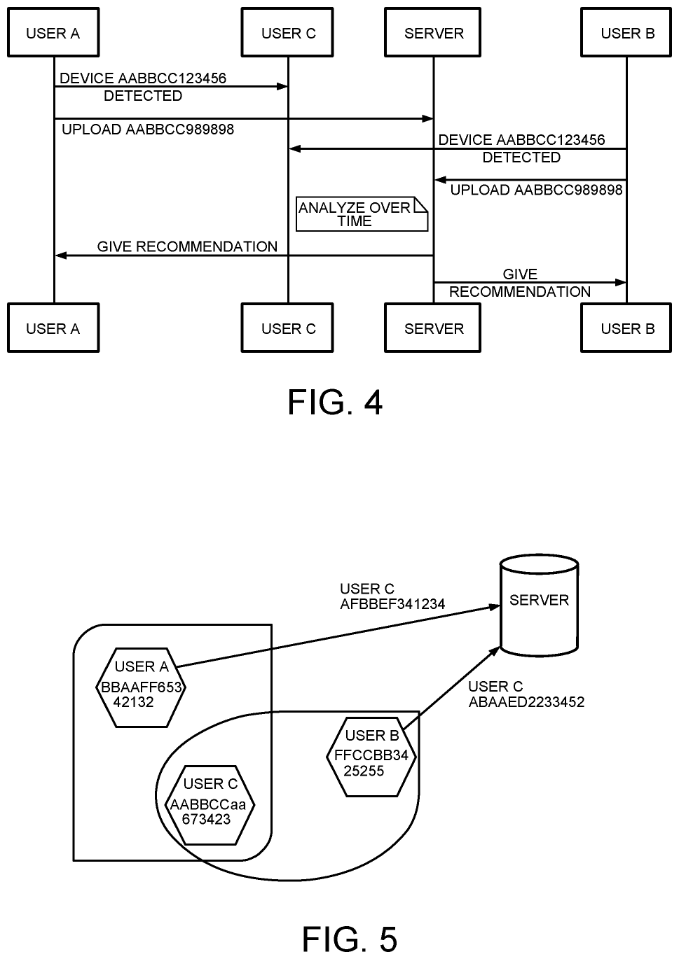

Therefore, for protecting user privacy, the exact Bluetooth address should not be shared with the backend for analysis, unless protected. The general flow from device detection to recommendation via analysis is described in FIG. 4.

Strong Local Protection:

Each app generates a unique and persistent identifier ID. This ID can be used to hash or encrypt the remote Bluetooth device address. For example, the Bluetooth address AABBCCDDEEFF11 would be 45fe12aa673423. This means that even if user A and user B see the same device, they will report different identifiers to the computer/server. Recognition can only be accomplished by the same reporting device. Seeing the same beacon twice will generate the same result.

FIG. 5 illustrates an example of how the same device generates two different identifiers when reported to the server.

Strong Local Partial Protection:

The first three bytes of a Bluetooth address identify the manufacturer. By lowering the requirements slightly, the manufacturer could still be allowed to be identified while not exposing the device specific part of the Bluetooth address. For example, Bluetooth address: AABBCCDDEEFF11 would be AABBCCaa673423, where the first three bytes are preserved.

This allows detection of devices of the same brands and could potentially be tied into a position depending on other privacy settings. But the actual unique device identifier is not exposed, so there is no way to know if user A and user B actually detected the same device when they see a third user.

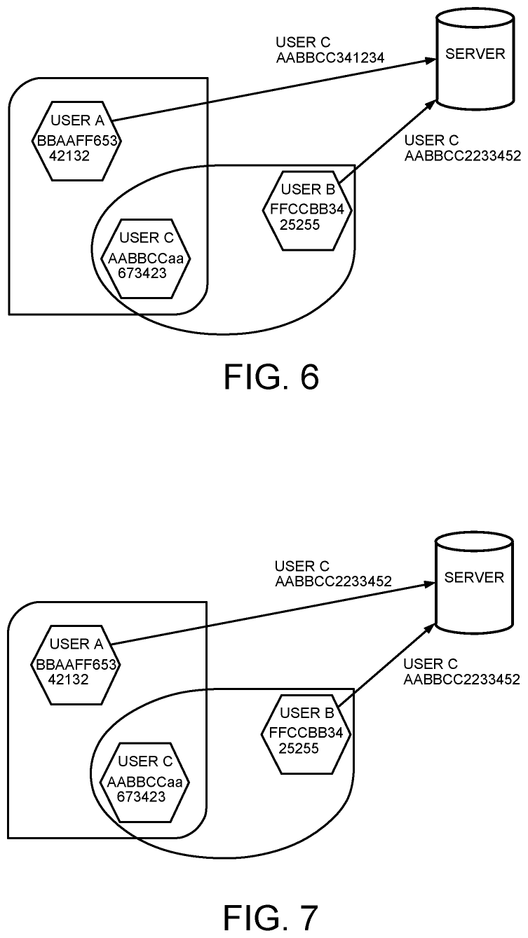

FIG. 6 illustrates an example in which user A and user B both report user C to the server, but only the manufacturer identifier of user C is preserved.

Distributed Protection:

The implementation examples described above are valid with regard to a single user. However, an alternative option is to privatize the personal information with a shared key or hash so that the result is always the same for the same device, regardless of which user encrypts the information. This allows for modeling of interactions between users and stationary beacons for different users of the same app. For example, user B has the Bluetooth address AABBCCDDEEFF11. When user A sees user B, he will report AABBCCaa673423 to the backend. When user C sees user B, he will also report AABBCCaa673423. This way it can be deduced that both user A and user C interact with user B, even though the exact details of user B's address are not shared. FIG. 7 is an illustration of how user A and user B would both report the same, anonymized identifier for user C, which in the case of FIG. 7 is AABBCC2233452.

Range Restrictions:

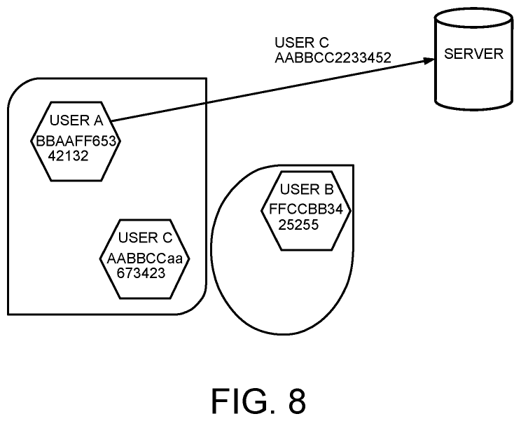

The maximum Bluetooth range (for v5.0) is about 120 meters. For users concerned about being associated with a remote device, their privacy can be enhanced by limiting the reported devices to ones that are within a restricted range. This is controlled by verifying that the RSSI value measured from the remote beacon is higher than a predetermined threshold, which correlates to a privacy level setting chosen by the user. FIG. 8 illustrates how user B's privacy settings eliminate user A from the devices reported for analysis because user A is outside of the predefined range.

Over time the reports received by the server, in any of the described embodiments, will allow computing a model of how the user interacts with other peers and devices. The model also allows the system to distinguish between random encounters versus repeat ones and devices that are part of the home scenario versus devices at work. The model can also be used anonymously to map circles of users to each other if they are all using the same platform. In contrast to other commercial and ad focused services, the model learns about users but yet preserves the privacy of both the user and the detected peers.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. Accordingly, various modifications, adaptations, and combinations of various features of the described embodiments can be practiced without departing from the scope of the invention as set forth in the claims.

1-12. (canceled)

13. A method for providing a location aware user model that preserves user privacy, the method comprising:
(a) collecting, by a sensor capture module of a mobile computing device of a user, sensor data from a plurality of sensors installed on the mobile computing device;
(b) processing the collected sensor data anonymously by associating the collected sensor data with individual heatspots, wherein the heatspots correspond to geographical areas of distinct significance to the user;
(c) labeling each of the heatspots with a unique identifier corresponding to one of the geographical areas, wherein the unique identifier does not reveal any geographical area; and
(d) generating, by a server, a location aware user model based on the unique identifiers corresponding to the geographical areas, wherein no information identifying the actual geographic areas in which the sensor data was sensed is transmitted to the server, wherein the location aware user model provides a recommendation to the user via the mobile computing device, and wherein the recommendation recommends that the user takes an action based on the sensor data and associated heatspots.

14. The method of claim 13, wherein the collected sensor data is selected from the group consisting of: accelerometer data, activity data, data about installed applications on the mobile computing device, data about a battery level of the mobile computing device, data about Bluetooth beacons in a heatspot, call logs, data about the mobile computing device including model, data indicating whether a headset of the mobile computing device is plugged in, internet logs, current lux level, location data, data indicating whether music is playing, ambient noise level, pedometer data, network data about the mobile computing device including roaming, operator, cell tower, TX/RX data, mobile versus WiFi, airplane mode, data about establishments in the heatspot, data indicating whether a screen of the mobile computing device is on, SMS logs, data indicating activity transitions of the user, and data indicating walking dynamics of the user.

15. A method for preserving privacy of sensor data, the method comprising:
collecting the sensor data from a plurality of sensors installed on a mobile computing device of a user;
grouping the sensor data by a plurality of heatspots in which the sensor data was sensed by the mobile computing device, wherein each of the heatspots corresponds to a geographic area that has a predetermined significance to the user;
labeling each of the heatspots with a unique identifier associated with the corresponding geographic area; and
transmitting from the mobile computing device the collected sensor data together with the unique identifier of the heatspot in which the sensor data was sensed, wherein information identifying the actual geographic area in which the sensor data was sensed is not transmitted.

16. The method of claim 15, wherein the transmitting of the collected sensor data together with the unique identifier of the heatspot does not reveal the physical whereabouts of the user.

17. The method of claim 15, wherein a first of the plurality of heatspots is the user's home, and wherein a second of the plurality of heatspots is the user's workplace.

18. The method of claim 15, further comprising:
transmitting from the mobile computing device the collected sensor data together with a timestamp indicative of when the sensor data was sensed.

19. The method of claim 15, further comprising:
transmitting from the mobile computing device the collected sensor data together with a timestamp indicative of when the mobile computing device entered the heatspot.

20. The method of claim 15, further comprising:
providing a recommendation to the user of the mobile computing device that depends on the geographic area in which the sensor data was sensed.

21. The method of claim 15, wherein the unique identifier is obfuscated using a hashing technique, further comprising:
receiving onto the mobile computing device an indication of the hashing technique, wherein the unique identifier is transmitted from the mobile computing device after being obfuscated using the hashing technique.

22. The method of claim 15, wherein the unique identifier is encrypted using at least a part of the location coordinates of the geographic area.

23. The method of claim 15, wherein the sensor data is selected from the group consisting of: location data of the mobile computing device, accelerometer data, pedometer data, data listing Bluetooth beacons identified by the mobile computing device, call logs of the mobile computing device, short message service (SMS) logs, and web surfing history on the mobile computing device.

24. The method of claim 15, wherein the heatspots correspond to geograhic areas whose radii range from five meters to a kilometer.

25. The method of claim 15, further comprising:
generating a location aware user model for the user using the collected sensor data and the unique identifier of the heatspot received from the mobile computing device.

26. A system for generating a location aware user model that preserves privacy of sensor data of a user, comprising:
a mobile computing device of the user that collects the sensor data from a plurality of sensors on the mobile computing device, wherein the mobile computing device groups the sensor data by a plurality of heatspots in which the sensor data was sensed by the mobile computing device, wherein each of the heatspots corresponds to a geographic area that has a predetermined significance to the user, and wherein each of the heatspots is labeled with a unique identifier associated with the corresponding geographic area; and
a server that receives from the mobile computing device the collected sensor data together with the unique identifier of the heatspot in which the sensor data was sensed, wherein information identifying the actual geographic area in which the sensor data was sensed is not received by the server, wherein the server generates the location aware user model based on the collected sensor data and the unique identifier, and wherein the location aware user model provides via the mobile computing device a recommendation to the user that depends on the geographic area in which the sensor data was sensed.

27. The system of claim 26, wherein a mobile app running on the mobile computing device groups the sensor data by the plurality of heatspots.

28. The system of claim 26, wherein the mobile computing device transmits to the server the collected sensor data together with a timestamp indicative of when the sensor data was sensed.

29. The system of claim 26, wherein the mobile computing device transmits to the server the collected sensor data together with timestamps indicative of when the mobile computing device entered each of the heatspots.

30. The system of claim 26, wherein the recommendation recommends that the user engage in an interactive therapy.

31. The system of claim 26, wherein the server transmits an indication of a hashing technique to the mobile computing device, wherein the mobile computing device obfuscates the unique identifier using the hashing technique, and wherein the mobile computing device transmits to the server the unique identifier that is obfuscated using the hashing technique.

32. The system of claim 26, wherein the sensor data is selected from the group consisting of: location data of the mobile computing device, accelerometer data of the mobile computing device, pedometer data of the mobile computing device, data listing Bluetooth beacons identified by the mobile computing device, call logs of the mobile computing device, short message service (SMS) logs of the mobile computing device, internet history on the mobile computing device, data about applications installed on the mobile computing device, data about a battery level of the mobile computing device, data identifying a model of the mobile computing device, and network data relating to the mobile computing device.
